(19) United States
(12) Patent Application Publication
(10) Pub. No.: US 2023/0095132 A1
(43) Pub. Date: Mar. 30, 2023

(54) MANUFACTURING METHOD OF GLASS PLATE HAVING HOLES, AND GLASS PLATE

(71) Applicant: AGC Inc., Tokyo (JP)

(72) Inventors: Mamoru ISOBE, Tokyo (JP); Kohei HORIUCHI, Tokyo (JP); Satoshi NAKAYAMA, Tokyo (JP)

(73) Assignee: AGC Inc., Tokyo (JP)

(21) Appl. No.: 17/931,198

(22) Filed: Sep. 12, 2022

(30) Foreign Application Priority Data
Sep. 24, 2021 (JP) 2021-155436

(51) Int. Cl. C03C 23/00; C03C 15/00

(52) U.S. Cl. CPC C03C 23/0025; C03C 15/00; C03C 23/002

(57) ABSTRACT

A manufacturing method of a glass plate having holes, includes: (1) having a first surface of a glass base material irradiated with a laser, to form initial holes each having a first initial opening, wherein each initial hole is an initial through hole or non-through hole, wherein the first initial opening has a maximum dimension φ_{1S} of 5 μm or greater, and wherein in each initial hole, denoting a depth as d₁, an aspect ratio (d₁/φ_{1S}) is 15 or greater; and (2) etching the glass base material with an alkaline solution, to form processed holes from the initial holes, wherein each processed hole has a first opening on the first surface, and wherein the first opening has a diameter φ₁ defined as an average of diameters of circumscribed and inscribed circles of the first opening, and a roundness P₁, and a ratio P₁/φ₁ is 10% or less.

### CROSS-REFERENCE TO RELATED APPLICATIONS

The present application is based upon and claims the benefit of priority to Japanese Patent Application No. 2021-155436 filed on Sep. 24, 2021, the entire contents of which are hereby incorporated by reference.

### BACKGROUND OF THE INVENTION

### 1. Field of the Invention

The present disclosure relates to a manufacturing method of a glass plate having holes, and relates to a glass plate.

### 2. Description of the Related Art

A glass plate having holes, for example, through holes or the like, has needs for many applications such as a glass interposer.

Such a glass plate is manufactured by, for example, having one surface of a glass base material irradiated with a laser to form holes, and then, applying a wet etching process to the glass base material to adjust shapes of the holes.

See, for example, Japanese Laid-Open Patent Application No. 2006-176355 (Patent Document 1); Published Japanese Translation of PCT International Application No. 2018-531205 (Patent Document 2); and WO No. 2020/149040 (Patent Document 3).

In general, a hydrofluoric acid solution is used for the wet etching process of the glass base material described above.

However, it has been known that when an etching process of holes is carried out using a hydrofluoric acid solution, the shapes of the holes often deviate from a desired shape, and it is difficult to form holes having a desired shape with high accuracy.

Note that Patent Documents 1 to 3 propose carrying out wet etching of a glass base material using an alkaline solution.

According to these documents, the glass base material is first irradiated with a laser to form modified portions. Thereafter, an etching process is applied to the glass base material with an alkaline solution, to form holes in the modified portions.

However, according to the experience of the inventors in the present disclosure, in the case of forming holes are by such a method, it is recognized that the shapes of the openings of the holes deviate from a desired shape, and an opening close to a perfect circle cannot be obtained.

Therefore, even if any of the methods described in Patent Documents 1 to 3 is adopted, it is difficult to form holes that are controlled highly precisely.

### SUMMARY

According to the present inventive concept, a manufacturing method of a glass plate having one or more holes includes:

(1) having a first surface of a glass base material irradiated with a laser, to form one or more initial holes each having a first initial opening on the first surface, the glass base material having the first surface and a second surface opposite to each other,

wherein each of the one or more initial holes is an initial through hole or an initial non-through hole,

wherein the first initial opening has a maximum dimension φ_{1S} (μm) of greater than or equal to 5 μm, and

wherein in each of the one or more initial holes, denoting a depth of the initial hole as d₁ (μm), an aspect ratio (d₁/φ_{1S}) of the initial hole is greater than or equal to 15; and

(2) applying an etching process to the glass base material with an alkaline solution, to form one or more processed holes from the one or more initial holes,

wherein each of the one or more processed holes has a first opening on the first surface, and

wherein the first opening has a diameter pi (μm) defined as an average of a diameter of a circumscribed circle and a diameter of an inscribed circle of the first opening, and a roundness P₁ (μm), and a ratio P₁/φ₁ is less than or equal to 10% for each of the processed holes.

Also, according to the present inventive concept, a glass plate is provided that includes a first surface and a second surface opposite to each other; and a plurality of through holes penetrating from the first surface to the second surface,

wherein each of the through holes has a first opening on the first surface and a second opening on the second surface, a larger one of the first opening and the second opening being referred to as a specific opening,

wherein the specific opening has a diameter φ_{T}(μm) determined as an average of a diameter of a circumscribed circle and a diameter of an inscribed circle of the specific opening, and a roundness P_{T}(μm), and a ratio P_{T}/φ_{T} is less than or equal to 10% for each of the through holes,

wherein, denoting an average value of the diameter φ_{T} of the specific opening among the through holes as φ_{Tave} (μm), and denoting the standard deviation of the diameter φ_{T} as σ (μm), 3σ/φ_{Tave} is less than or equal to 0.1, and

wherein, referring to five through holes selected at random from among the through holes as selected through holes, and denoting a minimum dimension of a narrow segment in cross section of each of the selected through holes as φ_{N} (μm), φ_{N}/φ_{T} is greater than or equal to 0.5 for each of the selected through holes.

### BRIEF DESCRIPTION OF DRAWINGS

FIG. 1 is a diagram schematically illustrating cross-sectional shapes of through holes formed in a glass base material by a conventional method;

FIG. 2 schematically illustrates cross-sectional shapes of non-through holes formed in a glass base material by a conventional method;

FIG. 3 is a flowchart schematically illustrating an example of a manufacturing method of a glass plate according to one embodiment in the present disclosure;

FIG. 4 is a diagram schematically illustrating one step of the manufacturing method of a glass plate according to the one embodiment in the present disclosure;

FIG. 5 is a diagram schematically illustrating one step of the manufacturing method of a glass plate according to the one embodiment in the present disclosure;

FIG. 6 is a diagram schematically illustrating one step of the manufacturing method of a glass plate according to the one embodiment in the present disclosure;

FIG. 7 is a flowchart schematically illustrating an example of a manufacturing method of a glass plate according to another embodiment in the present disclosure;

FIG. 8 is a diagram schematically illustrating one step of a manufacturing method of a glass plate according to another embodiment in the present disclosure;

FIG. 9 is a diagram schematically illustrating one step of a manufacturing method of a glass plate according to another embodiment in the present disclosure;

FIG. 10 is a diagram schematically illustrating one form of a cross section of a glass plate according to the one embodiment in the present disclosure;

FIG. 11 is a diagram illustrating an example of a cross-sectional photograph of initial through holes according to the one embodiment in the present disclosure (Example 1);

FIG. 12 is a diagram illustrating an example of a photomicrograph of through holes after an etching process according to the one embodiment in the present disclosure (Example 1);

FIG. 13 is a diagram illustrating an example of a cross-sectional photograph of initial through holes according to the one embodiment in the present disclosure (Example 2);

FIG. 14 is a diagram illustrating an example of a photomicrograph of through holes after an etching process according to the one embodiment in the present disclosure (Example 2);

FIG. 15 is a diagram illustrating an example of a photomicrograph of through holes after an etching process according to the one embodiment in the present disclosure (Example 3);

FIG. 16 is a diagram illustrating an example of a photomicrograph of the through holes after an etching process according to a comparative example (Example 21);

FIG. 17 is a diagram illustrating an example of a photomicrograph of the through holes after an etching process according to a comparative example (Example 22); and

FIG. 18 is a diagram illustrating an example of a photomicrograph of the through holes after the etching process according to a comparative example (Example 23).

### DESCRIPTION OF THE PREFERRED EMBODIMENTS

In the following, with reference to the drawings, one embodiment in the present disclosure will be described.

According to the present inventive concept, a manufacturing method of a glass plate having holes whose shapes are closer to a desired shape can be provided. Also, according to the present inventive concept, a glass plate having holes whose shapes are closer to a desired shape can be provided.

Note that in the present application, a glass to be processed before an etching process will be referred to as a “glass base material”, and the glass to be processed after the etching process will be referred to as a “glass plate”, to tentatively distinguish the two. According to these definitions, a “glass base material” means a glass to be processed having no holes before laser irradiation, and a glass to be processed having initial holes formed by laser irradiation. On the other hand, a “glass plate” means a “glass base material” having holes whose shapes are improved by the etching process. However, such distinction is merely for the sake of convenience, and from the viewpoint of readability of the specification, in some cases, a “glass plate” after the etching process is also referred to as a “glass base material”.

As described above, in a manufacturing method of a glass plate having holes, a problem often arises that holes having a desired shape cannot be obtained when a wet etching process using hydrofluoric acid is carried out.

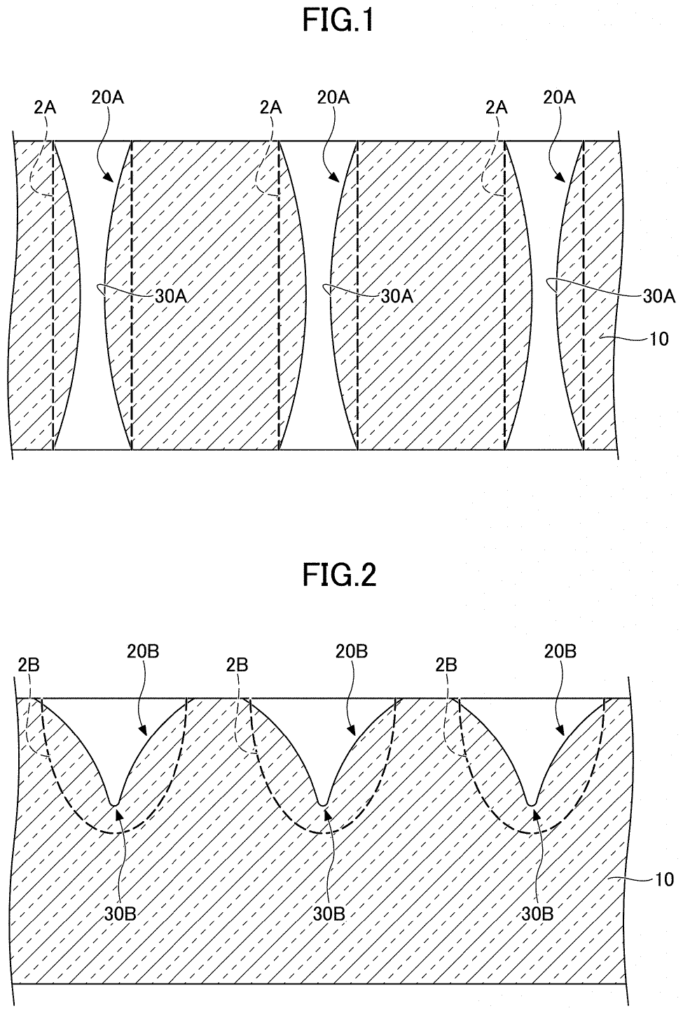

FIG. 1 schematically illustrates cross-sectional shapes of through holes formed by a conventional method. In FIG. 1, dashed lines indicate a profile of ideal through holes.

As illustrated in FIG. 1, a through hole 20A formed in a glass plate 10 by the conventional method has a cross-sectional shape of a substantially hourglass shape. In other words, the through hole 20A has a “narrow segment” 30A internally at which the diameter is smaller compared to the profile 2A of the ideal through hole.

Also, FIG. 2 schematically illustrates cross-sectional shapes of non-through holes formed by a conventional method. In FIG. 2, dashed lines indicate a profile of ideal non-through holes.

As illustrated in FIG. 2, a non-through hole 20B formed in a glass plate 10 by the conventional method has a cross section of a substantially inverted triangle. In other words, the non-through hole 20B has a diameter not sufficiently widened at the deepest portion as compared to a profile 2B of an ideal non-through hole, and has a sharp “apex” 30B.

In this way, cases are often recognized in that the shapes of the through holes 20A and the non-through holes 20B after an etching process deviate from desired shapes.

The inventors in the present disclosure consider that the through holes 20A and the non-through holes 20B are not formed in the desired shapes because a hydrofluoric acid solution is used in the wet etching process.

In other words, a hydrofluoric acid solution has a relatively high etching rate for a glass base material. Therefore, when a residue (an insoluble product generated by etching) is formed in a hole during the etching using the hydrofluoric acid solution, before the residue is removed from the hole, the other part of the hole is etched. Thereafter, the residue hinders the progress of etching in the hole locally in this way; and as a consequence, it can be considered that a narrow segment 30A is formed in the case of a through hole 20A, and an apex 30B is formed in the case of a non-through hole 20B.

In particular, in the case where the aspect ratios of the through hole 20A and the non-through hole 20B are high, it is expected that such an effect becomes more significant.

In this way, in the conventional method, there is a problem that it is difficult to form highly precisely controlled holes in a glass base material.

Note that as a countermeasure against such a problem, it is conceivable to reduce the concentration of hydrofluoric acid used in the etching process.

However, in the case of using a hydrofluoric acid solution having a low concentration, there is a problem that the hydrofluoric acid is consumed intensively, and hence, the etching function is deteriorated in a relatively short time. Therefore, such a countermeasure is not suitable for industrial production of glass plates having holes.

Also, Patent Documents 1 to 3 describe methods of etching laser-modified portions using an alkaline solution.

However, the inventors of the present application have recognized that in the methods described in Patent Documents 1 to 3, the shape of an opening of a finally formed hole deviates from a desired dimension, and an opening close to a perfect circle cannot be obtained. Therefore, even in the case of adopting any of the methods described in Patent Documents 1 to 3, it is difficult to form holes that are controlled highly precisely.

Note that as a reason why an opening having a desired shape cannot be obtained in the hole after the etching process in the methods described in Patent Documents 1 to 3, the following can be considered.

In Patent Documents 1 to 3, first, laser-modified portions extending in the depth direction are formed by having a glass base material irradiated with a laser. Next, by etching the glass base material having the modified portions, each of the laser-modified portions is selectively etched to form a hole.

Here, in order to form a hole having a desired diameter using the laser-modified portion as a base point, it is necessary to selectively remove the laser-modified portion having been in contact with the etching solution (initially, only on the surface of the glass base material), and then, to “expand” the removed portion in the extending direction and in the radial direction.

However, during such “expansion”, the glass base material is not necessarily removed isotropically, especially in the radial direction of the hole. Therefore, it is considered that, in such a method, the shape of the opening of the finally obtained hole deviates from a perfect circle.

In contrast, according to one embodiment in the present disclosure, a manufacturing method of a glass plate having one or more holes is provided that includes: (1) having a first surface of a glass base material irradiated with a laser, to form one or more initial holes each having a first initial opening on the first surface, the glass base material having the first surface and a second surface opposite to each other,

wherein each of the one or more initial holes is an initial through hole or an initial non-through hole,

wherein the first initial opening has a maximum dimension φ_{1S} (μm) of greater than or equal to 5 μm, and wherein in each of the one or more initial holes, denoting a depth of the initial hole as d₁ (μm), an aspect ratio (d₁/φ_{1S}) of the initial hole is greater than or equal to 15; and

(2) applying an etching process to the glass base material with an alkaline solution, to form one or more processed holes from the one or more initial holes,

wherein each of the one or more processed holes has a first opening on the first surface, and

wherein the first opening has a diameter pi (μm) defined as an average of a diameter of a circumscribed circle and a diameter of an inscribed circle of the first opening, and a roundness P₁ (μm), and a ratio P₁/φ₁ is less than or equal to 10% for each of the processed holes.

According to the one embodiment in the present disclosure, an alkaline solution is used during the etching process of the holes.

The alkaline solution has an etching rate lower than the hydrofluoric acid solution. However, by carrying out the etching process of the holes at such a low etching rate, the amount of residue generated per unit time can be reduced, and at the same time, a sufficient time can be provided for the residues to escape from the holes to the outside.

Therefore, according to the one embodiment in the present disclosure, even when the aspect ratio of the hole is high, the problem that the progress of etching is hindered by the residue can be suppressed significantly. As a result, after the etching process, a hole having a shape closer to a desired shape can be formed.

Also, according to the one embodiment in the present disclosure, a hole having an opening is formed in the glass base material by laser irradiation, and the etching process of the hole is started with the hole as a starting shape.

In this case, unlike the case of starting an etching process with a modified portion as a starting shape, the etching can be carried out using a hole having an opening in advance. Therefore, after the etching solution is filled in the hole, the hole can be etched more isotropically along the radial direction. As a result, a hole that has an opening having a shape closer a desired shape and a desired profile in the depth direction, can be obtained.

Thanks to the above effects, in the method according to the one embodiment in the present disclosure, a glass plate having holes whose shapes are closer to a desired shape including an opening can be provided. In particular, in the method according to the one embodiment in the present disclosure, a profile closer to a desired shape can be obtained even in the case of a hole having a high aspect ratio.

Note that in the present application, the aspect ratio is normally defined by (depth of a hole)/(diameter of the opening on the surface on the laser irradiation side).

However, in the case where the opening is not a perfect circle, the maximum dimension of the opening may be used instead of the diameter of the opening.

### Manufacturing Method of a Glass Plate According to the One Embodiment in the Present Disclosure

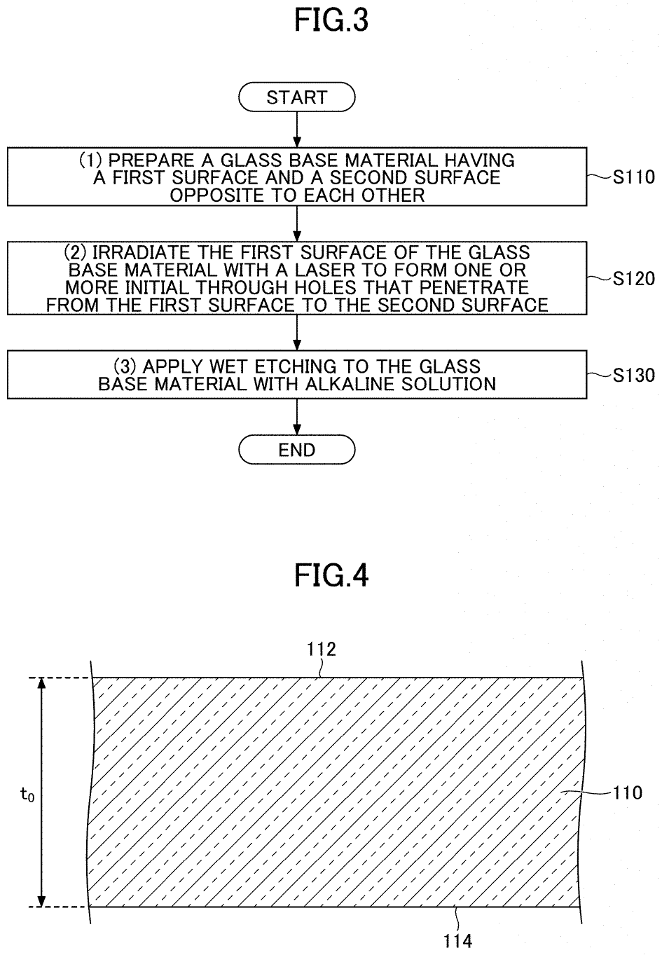

Next, with reference to FIGS. 3 to 6, the manufacturing method of a glass plate according to the one embodiment in the present disclosure will be described in more detail.

FIG. 3 schematically illustrates an example of a flow of the manufacturing method of a glass plate according to the one embodiment in the present disclosure.

As illustrated in FIG. 3, the manufacturing method of a glass plate according to the one embodiment in the present disclosure (hereafter, referred to as a “first method”) includes:

(1) a step of preparing a glass base material having a first surface and a second surface opposite to each other (S110);
(2) a step of having the first surface of the glass base material irradiated with a laser, to form one or more initial through holes penetrating from the first surface to the second surface (S120); and
(3) a step of wet etching the glass base material with an alkaline solution (S130).

In the following, each of the steps will be described.

### (Step S110)

First, a glass base material is prepared.

FIG. 4 schematically illustrates a cross section of a glass base material 110. The glass base material 110 has a first surface 112 and a second surface 114 opposite to each other.

The composition of the glass base material 110 is not limited in particular as long as it is glass. However, in the case of quartz glass, even if an etching process is carried out using a hydrofluoric acid solution, a residue is not generated in a significant quantity. Therefore, with quartz glass, the need to use the first method is not very high.

The glass base material 110 may be, for example, soda-lime glass, non-alkali glass, crystallized glass, or the like.

The dimensions of the glass base material 110 are not limited in particular. However, the effects of the one embodiment in the present disclosure can be felt more with a relatively thick glass base material 110. The glass base material 110 may have a thickness (t₀) of, for example, greater than or equal to 0.1 mm.

### (Step S120)

Next, the first surface 112 of the glass base material 110 is irradiated with a laser to form initial through holes.

The type of laser is not limited in particular as long as initial through holes can be formed in the glass base material 110. The laser may be, for example, a UV laser.

Also, although the irradiation condition of the laser is not limited in particular, it is favorable that the laser to be used is a pulse laser such as a femtosecond laser or a nanosecond laser. In this case, a large number of initial through holes can be formed by a single scan.

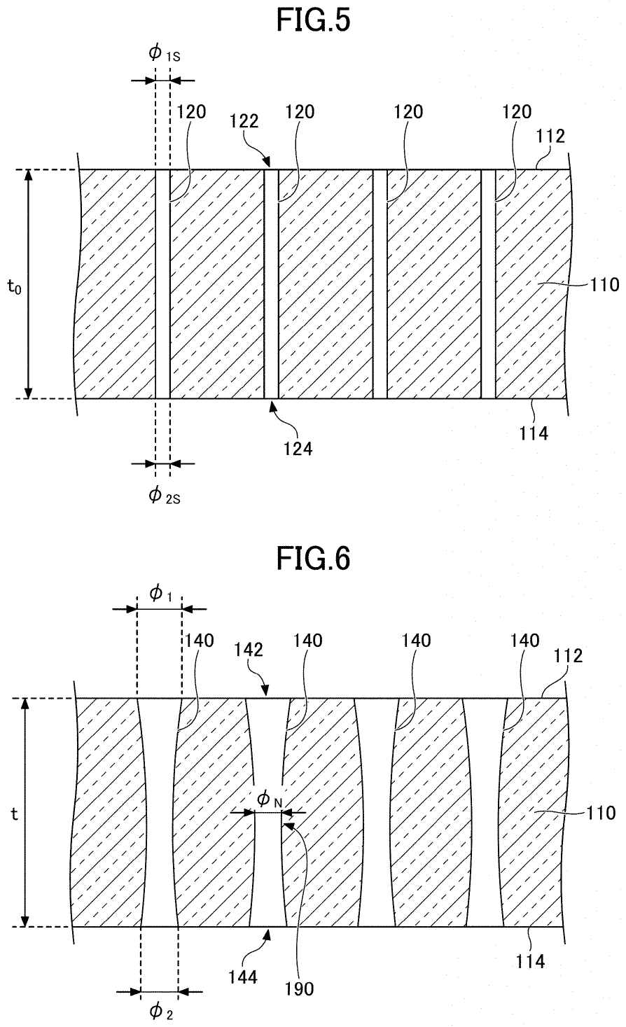

FIG. 5 schematically illustrates a cross section of the glass base material 110 after the laser irradiation.

As illustrated in FIG. 5, by carrying out the laser irradiation, multiple initial through holes 120 penetrating from the first surface 112 to the second surface 114 are formed in the glass base material 110. Note that in the example illustrated in FIG. 5, the first surface 112 is an incidence surface of the laser.

For each of the initial through holes 120, an opening on the first surface 112 will be referred to as a first initial opening 122, and an opening on the second surface 114 will be referred to as a second initial opening 124. Also, the maximum value of the dimension of the first initial opening 122 is denoted as φ_{1S}, and the maximum value of the dimension of the second initial opening 124 is denoted as φ_{2S}.

In a normal case, the first initial opening 122 and the second initial opening 124 are substantially elliptic (including circular; the same applies to the following), and hence, it is considered that, in many cases, each of the maximum dimension φ_{1S} of the first initial opening 122 and the maximum dimension φ_{2S} of the second initial opening 124, corresponds to the dimension of the major axis of an ellipse (or the diameter of a circle).

Note that in a normal case, an inequality of the maximum dimension φ_{1S}≥the maximum dimension φ_{2S} holds. In other words, it is often the case that the initial through hole 120 has a generally tapered shape whose cross-sectional dimension gradually decreases from the first initial opening 122 toward the second initial opening 124.

The maximum dimension (is of the first initial opening 122 is, for example, within a range of 5 μm to 30 μm. Similarly, the maximum dimension φ_{2S} of the second initial opening 124 is, for example, within a range of 1 μm to 10 μm.

Also, the aspect ratio of the initial through hole 120 is greater than or equal to 15.

Here, as described above, the aspect ratio of the initial through hole 120 is expressed by (the depth of the initial through hole 120)/(the maximum dimension (is of the first initial opening 122). Here, an equality of (the depth of the initial through hole 120)=(the thickness to of the glass base material 110) holds.

However, the maximum dimension φ_{1S}, the maximum dimension φ_{2S}, and the aspect ratio may vary depending on the dimensions of the through hole to be finally formed.

### (Step S130)

Next, wet etching is applied to the glass base material 110 having the initial through holes 120.

In the first method, the wet etching process is carried out using an etching solution that includes an alkaline component.

The etching solution may include, for example, KOH, NaOH, or KOH and NaOH as the alkaline component. Also, the etching solution may further include a chelating agent such as ethylenediaminetetraacetic acid (EDTA).

The content of the alkaline component is, for example, within a range of 1 M to 10 M, although not limited in particular.

The temperature during the etching process is, for example, within a range of 50° C. to 95° C., although not limited in particular.

The etching rate of the etching solution to be used is, for example, less than or equal to 0.4 μm/min. It is favorable that the etching rate of the etching solution is less than or equal to 0.1 μm/min.

In the present application, the etching rate is determined by (reduction in thickness of the glass base material before and after the etching process)/(processing time).

FIG. 6 schematically illustrates a cross section of the glass base material 110 (which may also be referred to as a glass plate) after the wet etching process.

As illustrated in FIG. 6, the wet etching process etches the initial through holes 120, to form processed through holes 140.

Note that during the etching process, the surfaces of the glass base material 110 are also etched, and hence, the thicknesses of the glass base material 110 changes to t from t₀ before the processing. Therefore, the first surface 112 and the second surface 114 of the glass base material 110 are changed to new surfaces, respectively, after the processing.

However, in the present application, in order to avoid complicated description, the surfaces of the glass base material 110 opposite to each other after the etching process will be referred to as the “first surface 112” and the “second surface 114” as they have been.

Each of the processed through holes 140 has a first opening 142 on the side of the first surface 112 and a second opening 144 on the side of the second surface 114. The first opening 142 and the second opening 144 may have a generally elliptic shape.

The diameter φ₁ of the first opening 142 is, for example, within a range of 20 μm to 100 μm. The diameter φ₂ of the second opening 144 is, for example, within a range of 20 μm to 100 μm.

Note that the diameter φ₁ of each of the first opening 142 is determined as an average of the diameter of a circumscribed circle and the diameter of an inscribed circle of the first opening 142. Similarly, the diameter φ₂ of each of the second opening 144 is determined as an average of the diameter of a circumscribed circle and the diameter of an inscribed circle of the second opening 144.

Also, the aspect ratio (t/φ₁) of the processed through hole 140 may be, for example, greater than or equal to 1.

Here, in each of the processed through holes 140, the roundness of the first opening 142 is denoted as P₁ (μm); the roundness P₁ is determined by the following Formula (1):

P₁=(the diameter of the circumscribed circle of the first opening−the diameter of the inscribed circle of the first opening)/2 Formula (1)

Also, using this roundness P₁, when determining a value of a ratio P₁/φ₁ obtained for each of the processed through holes 140, this value represents “closeness” of the shape of the first opening 142 to a perfect circle. In other words, it can be stated that a first opening 142 having a smaller P₁/φ₁ is closer to a perfect circle.

In the first method, the processed through holes 140 to be formed have a feature that the ratio P₁/φ₁ is less than or equal to 10%. In other words, in the first method, the first opening 142 having a shape close to a perfect circle is obtained in a corresponding processed through hole 140.

It is favorable that the ratio P₁/φ₁ is, for example, less than or equal to 5%, or less than or equal to 2%.

It is favorable that each of the processed through holes 140 has a profile having an equal cross-sectional dimension along the extending direction (thickness direction of the glass base material 110), or a profile having a cross-sectional dimension monotonically decreasing from the first opening 142 toward the second opening 144.

However, in practice, as illustrated in FIG. 6, the processed through hole 140 often has a somewhat narrow segment 190 internally. However, even in such a case, in each of the processed through holes 140, the narrow segment 190 is suppressed within an allowable range.

Through the above steps, a glass plate having one or more processed through holes 140 can be manufactured.

In the first method, in the obtained glass plate, each of the processed through holes 140 has a shape close to a desired shape.

For example, in a glass plate manufactured by the first method, referring to five processed through holes 140 selected at random as “selected through holes”, and denoting the minimum dimension of each narrow segment 190 in the cross section of each “selected through hole” as φ_{N}(μm), φ_{N}/φ₁ may be greater than or equal to 0.5 for each of the selected through holes. In particular, it is favorable that φ_{N}/φ₁ is greater than or equal to 0.6, and it is more favorable to be greater than or equal to 0.7.

In this way, in the first method, the narrow segment 190 that could be formed in the processed through hole 140 is significantly suppressed. Therefore, in a glass plate manufactured by the first method, the processed through holes 140 can be appropriately filled with a conductive material.

Also, the processed through hole 140 has a shape of the first opening 142 that is closer to a perfect circle. Therefore, when each of the processed through holes 140 is filled with a conductive material, the positional accuracy of a corresponding conductive portion on the first surface 112 of the glass plate can be increased significantly.

### Manufacturing Method of a Glass Plate According to Another Embodiment in the Present Disclosure

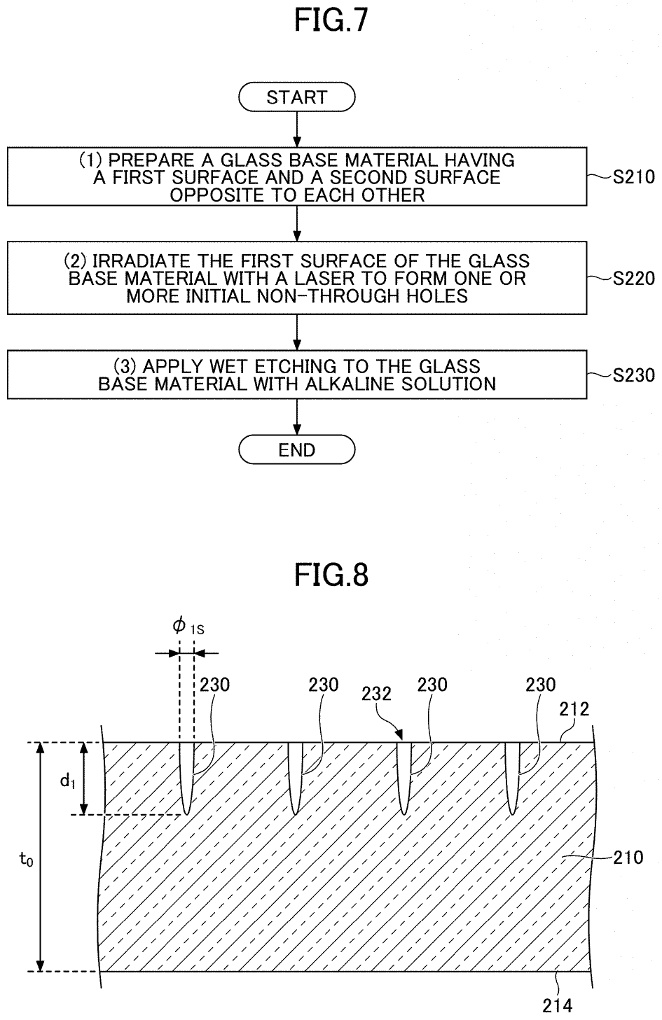

Next, with reference to FIGS. 7 to 9, a manufacturing method of a glass plate according to another embodiment in the present disclosure will be described.

FIG. 7 schematically illustrates an example of a flow of the manufacturing method of a glass plate according to the other embodiment in the present disclosure.

As illustrated in FIG. 7, a manufacturing method of a glass plate according to another embodiment in the present disclosure (hereafter, referred to as the “second method”) includes:

(1) a step of preparing a glass base material having a first surface and a second surface opposite to each other (S210)
(2) a step of having the first surface of the glass base material irradiated with a laser, to form one or more initial non-through holes (S220); and
(3) a step of wet etching the glass base material with an alkaline solution (S230).

Note that the second method is different from the first method described above, in that holes formed at Step S220 are initial non-through holes. In other words, the second method, Step S210 is substantially the same as Step S110 in the first method. Therefore, here, Steps S220 and thereafter will be described.

### (Step S220)

In the second method, the first surface of a glass base material is irradiated with a laser to form initial non-through holes. As the laser, those described in the first method can be used.

FIG. 8 schematically illustrates a cross section of a glass base material 210 after the laser irradiation.

As illustrated in FIG. 8, the glass base material 210 has a first surface 212 and a second surface 214 opposite to each other. Also, in the glass base material 210, multiple initial non-through holes 230 each having a first initial opening 232 at a first surface 212, are formed. Note that in FIG. 8, the first surface 212 of the glass base material 210 is an incidence surface of the laser.

In each of the initial non-through holes 230, the maximum value of the dimension of the first initial opening 232 is denoted as φ_{1S}.

In a normal case, the first initial opening 232 is substantially elliptic, and hence, it is considered that, in many cases, the maximum dimension (is of the first initial opening 232 corresponds to the dimension of the major axis of the ellipse (or the diameter of the circle).

Note that in a normal case, it is often the case that the initial non-through hole 230 has a generally tapered shape whose cross-sectional dimension gradually decreases in the extending direction from the first initial opening 232.

The maximum dimension (is of the first initial opening 232 is, for example, within a range of 5 μm to 30 μm.

Also, the aspect ratio of the initial non-through hole 230 is greater than or equal to 15. Here, as described above, the aspect ratio of the initial non-through hole 230 is expressed by (the depth d₁ of the initial non-through hole 230)/(the maximum dimension (is of the first initial opening 232).

However, these values are determined according to the dimensions of non-through holes to be finally formed.

### (Step S230)

Next, wet etching is applied to the glass base material 210 having the initial non-through holes 230.

In the second method, the conditions of the etching process are the same as those in the first method. For example, the process solution includes an alkaline component such as KOH, NaOH, or KOH and NaOH. Also, the temperature during the etching process may be, for example, within a range of 50° C. to 95° C.

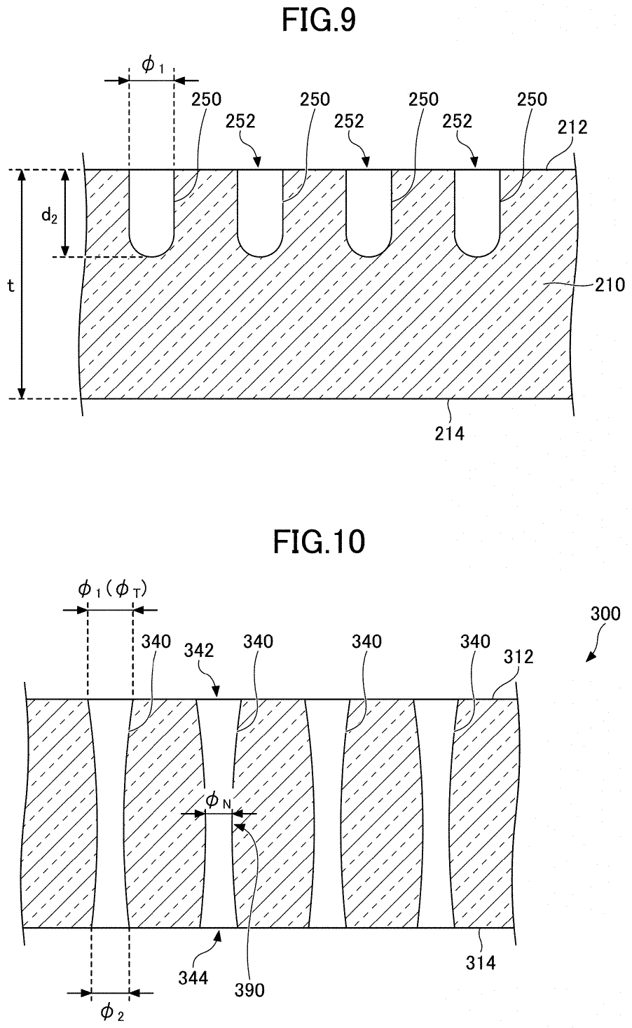

FIG. 9 schematically illustrates a cross section of the glass base material 210 (which may be referred to as a glass plate) after the wet etching process.

As illustrated in FIG. 9, the wet etching process etches the initial non-through holes 230, to form processed non-through holes 250.

Each of the processed non-through holes 250 has a first opening 252 on the side of the first surface 212. The first opening 252 may have a generally elliptic shape.

The diameter φ₁ of the first opening 252 is, for example, within a range of 20 μm to 100 μm. As described above, the diameter φ₁ of the first opening 252 is determined as an average of the diameter of a circumscribed circle and the diameter of an inscribed circle of the first opening 252.

Also, when denoting the depth of the processed non-through hole 250 as d₂ (μm), the aspect ratio, i.e., a ratio d₂/φ₁ may be, for example, greater than or equal to 1.

Here, in each of the processed non-through holes 250, denoting the roundness of the first opening 252 as P₁ (μm), the ratio P₁/φ₁ is less than or equal to 10%. In other words, in the second method, the first opening 252 having a shape close to a perfect circle is obtained in a corresponding through hole 250.

It is favorable that the ratio P₁/φ₁ is, for example, less than or equal to 5%, or less than or equal to 2%.

It is favorable that each of the processed non-through holes 250 has a profile having an equal cross-sectional dimension along the extending direction (thickness direction of the glass base material 210), or a profile having a cross-sectional dimension monotonically decreasing in the depth direction from the first opening 252.

Through the above steps, a glass plate having the processed non-through holes 250 can be manufactured.

Also in the second method, as in the first method, a glass plate having processed non-through holes 250 each having a shape close to a desired shape can be manufactured.

### Glass Plate According to the One Embodiment in the Present Disclosure

Next, with reference to FIG. 10, a glass plate and its features according to the one embodiment in the present disclosure will be described.

FIG. 10 schematically illustrates one form of a cross section of a glass plate according to the one embodiment in the present disclosure.

According to the one embodiment in the present disclosure, the glass plate 300 may be glass other than quartz glass, for example, soda-lime glass, non-alkali glass, or crystallized glass.

The dimensions of the glass plate 300 are not limited in particular. The glass plate 300 may have a thickness of, for example, greater than or equal to 0.1 mm.

The glass plate 300 has a first surface 312 and a second surface 314 opposite to each other. Also, the glass plate 300 has multiple through holes 340 penetrating from the first surface 312 to the second surface 314. In other words, each of the through holes 340 has a first opening 342 on the side of the first surface 312 and a second opening 344 on the side of the second surface 314.

The first opening 342 has a diameter φ₁ (μm), and the second opening 344 has a diameter φ₂ (μm).

As described above, the “diameter” of the opening of each of the through holes 340 is determined as an average of the diameter of the circumscribed circle and the diameter of the inscribed circle.

As illustrated in FIG. 10, in the glass plate 300 according to the one embodiment in the present disclosure, each of the through holes 340 may have a narrow segment 390 internally. However, in the glass plate 300, the narrow segments 390 are suppressed within a predetermined range as will be described later.

Such a glass plate 300 can be manufactured by, for example, the first method described above.

Here, in each of the through holes 340, a larger opening among the first opening 342 and the second opening 344 will be referred to as a “specific opening”. Further, the diameter of the “specific opening” is denoted as “φ_{T}”.

Note that for each of the through holes 340, an opening (e.g., first opening 342) on one surface (e.g., first surface 312) of the glass plate 300 does not always correspond to a “specific opening”. In other words, there may be a case where the first opening 342 corresponds to the “specific opening” in one through hole 340, and the second opening 344 corresponds to the “specific opening” in another through hole 340.

This is because in an actual manufacturing process of a glass plate, etching of the opening on one side may be prioritized when carrying out the etching process of the initial through holes.

Also, in some of the through holes 340, there may be no substantial difference in dimension between the first opening 342 and the second opening 344. In this case, either one of the first surface 312 and the second surface 314 is regarded the “specific opening”.

However, here, for the sake of simplicity, assume that the first opening 342 is the specific opening in every through hole 340. Also, assume that the first surface 312 of the glass plate 300 is the laser irradiation surface.

In the glass plate 300 according to the one embodiment in the present disclosure, denoting the roundness of the specific opening of each of the through holes 340, i.e., the first opening 342, as P_{T} (μm), the ratio P_{T}/φ_{T} is less than or equal to 10% for each of the through holes 340.

As in Formula (1) described above, the roundness P_{T} of the specific opening can be determined by the following Formula (2):

P_{T}=(the diameter of the circumscribed circle of the specific opening−the diameter of the inscribed circle of the specific opening)/2 Formula (2)

As described above, the ratio P_{T}/φ_{T} represents “closeness” of the shape of the specific opening to a perfect circle. In other words, it can be stated that a specific opening having a smaller P_{T}/φ_{T} is closer to a perfect circle. Therefore, the glass plate 300 having an average of the ratio P_{T}/φ_{T} of less than or equal to 10% has specific openings closer to a perfect circle.

It is favorable that the ratio P_{T}/φ_{T} is, for example, less than or equal to 5%, or less than or equal to 2%.

Also, in the glass plate 300, denoting an average value of the diameters φ_{T} of the specific openings in the respective through holes 340 as φ_{Tave} (μm), and denoting the standard deviation of the diameter φ_{T} as σ (μm), 3σ/φ_{Tave} is less than or equal to 0.1.

This means that the variation in the diameters φ_{T} of the specific openings is small in the glass plate 300. Therefore, in the glass plate 300, it can be stated that each of the through holes 340 has a specific opening closer to a desired shape.

Further, referring to five through holes selected at random from among the through holes 340 as “selected through holes”, and denoting the minimum dimension of the narrow segment 390 in the cross section of each “selected through hole” as φ_{N} (μm), the glass plate 300 has a feature that φ_{N}/φ_{T} is greater than or equal to 0.5 for each of the selected through holes. In particular, it is favorable that φ_{N}/φ_{T} is greater than or equal to 0.6, and it is more favorable to be greater than or equal to 0.7.

In this way, in the glass plate 300, the narrow segment 390 is suppressed significantly.

In the glass plate 300 having the features as described above, the through holes 340 can be appropriately filled with a conductive material.

Also, the shape of the specific opening of the through hole 340 is close to a perfect circle; therefore, when each of the through holes 340 is filled with a conductive material, the positional accuracy of a corresponding conductive portion on the first surface of the glass plate 300 can be increased significantly.

### EXAMPLES

In the following, examples in the present disclosure will be described. Note that in the following description, Examples 1 to 3 are application examples, and Examples 21 to 23 are comparative examples.

### Example 1

A glass plate having a large number of through holes was formed by the first method described above.

As the glass base material, an alkali-free glass (AN100; manufactured by AGC Inc.) having a thickness of 0.5 mm was used.

In a state of the first surface of the glass base material onto which an absorber was applied, initial through holes were formed by having the first surface of the glass base material irradiated with a laser. As the laser, a nanosecond pulse UV laser was used. After 50 shots of laser irradiation with a pulse energy of 20 μJ, 1200 shots of laser irradiation with a pulse energy of 40 μJ were carried out. The repetition frequency at this time was set to 10 kHz, and after the initial through holes were formed, the absorber was removed.

Among the initial through holes, the maximum dimension φ_{1S} of the first initial opening formed on the first surface side of the glass base material was approximately 15 μm. Therefore, the aspect ratio of each of the initial through holes was approximately 33.3.

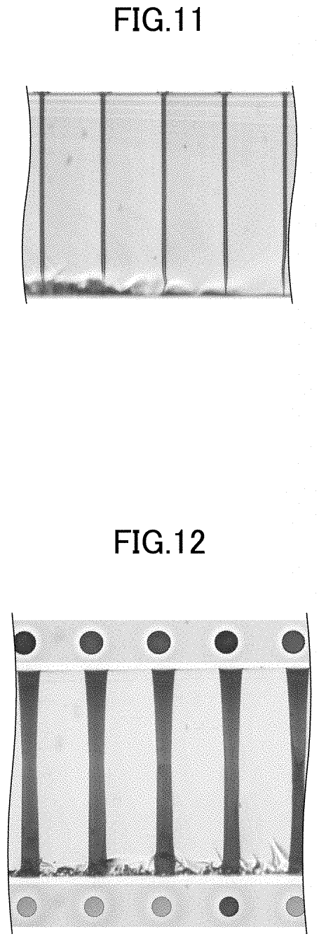

FIG. 11 illustrates an example of a cross-sectional photograph of formed initial through holes. From FIG. 11, it can be seen that initial through holes having a high aspect ratio were formed.

Next, this glass base material was immersed in an etching solution to carry out an etching process.

As the etching solution, an aqueous solution including NaOH of 3 M and EDTA of 1.5 M was used. The temperature of the etching solution was set to 85° C., and the immersion time was set to 744 minutes.

After the etching process, the glass base material was taken out of the etching solution, to measure the thickness. As a result, it was understood that the glass base material was thinned by 46 μm. Therefore, the etching rate during the applied etching process was 0.062 μm/min.

After the etching process, a glass plate was formed in which a large number of through holes were formed. Each of the through holes has a first opening on the side of the first surface of the glass plate, and a second opening on the side of the second surface.

### (Evaluation)

### (Measurement for First Openings)

The diameter (φ₁) and the roundness (P₁) of the opening (i.e., first opening) of each of the through holes on the laser irradiation side was measured by using a shape measuring device (VMR-Z6555; manufactured by Nikon Corporation). Also, from the obtained results, an average (φ₁ₐᵥₑ), (3σ/φ₁ₐᵥₑ), and the like of the first opening were obtained. Further, the ratio P₁/φ₁ was determined for each of the through holes, and the average, the minimum, and the maximum were determined.

Note that as described above, the diameter φ₁ of the first opening was determined as an average of the diameter of the circumscribed circle and the diameter of the inscribed circle. Also, the roundness P₁ was obtained from Formula (1) described above. Also, σ is the standard deviation.

Further, by observing cross sections of five through holes (selected through holes) selected in the glass plate by using an optical microscope, the minimum dimension (φ_{N}) of the narrow segment in each of the selected through holes was measured, to determine the average (φ_{Nave}). Also, for each of the selected through holes, the ratio φ_{N}/φ₁ was determined.

The measurement results are collectively shown in a column of Example 1 in Table 1 below.

TABLE 1

| | | Examples | | | | | |
|---|---|---|---|---|---|---|---|
| | | 1 | 2 | 3 | 21 | 22 | 23 |
| Number of through holes | | 81 | 81 | 81 | 765 | 765 | 102 |
| Diameter ϕ₁ | Average ϕ₁ₐᵥₑ (μm) | 51.2 | 51.2 | 44.2 | 93.5 | 100.4 | 28.9 |
| of first opening | 3σ (μm) | 0.9 | 3.4 | 2.3 | 7.3 | 16.5 | 1.9 |
| | 3σ/ϕ₁ₐᵥₑ (%) | 1.7 | 6.6 | 5.1 | 7.8 | 16.5 | 6.6 |
| P₁/ϕ₁ | Average (%) | 3.0 | 2.9 | 3.4 | 1.6 | 1.5 | 12.8 |
| among through | Maximum (%) | 6.2 | 6.7 | 3.9 | 6.1 | 4.9 | 16.6 |
| holes | Minimum (%) | 2.5 | 2.4 | 2.9 | 1.3 | 1.2 | 9.3 |

| | | | | | | |
|---|---|---|---|---|---|---|
| Average ϕ_{Nave} of the minimum dimension | 32.2 | 34.0 | 35.2 | 31.8 | 74.6 | 18.2 |
| ϕ_{N} of the narrow segment among | | | | | | |
| selected through holes (μm) | | | | | | |
| (ϕ_{N}/ϕ₁) (%) | 59 to 64 | 62 to 68 | 74 to 81 | 32 to 35 | 73 to 75 | 62 to 68 |

### (Measurement for Second Openings)

For each of the through holes, measurement of the second opening was carried out by using substantially the same method as described above (measurement for first openings).

From the obtained results, the specific opening in each of the through holes was determined. Also, various values for the specific openings were determined. Specifically, the average (φ_{Tave}), 3σ, and (3σ/φ_{Tave}) of the diameters of the specific openings, and the average, the minimum value, and the maximum value of the ratio P_{T}/φ_{T} of the through holes were determined.

Further, for the five selected through holes described above, the ratio φ_{N}/φ_{T} was determined.

The measurement results are collectively shown in a column of Example 1 in Table 2 below.

TABLE 2

| | | Examples | | | | | |
|---|---|---|---|---|---|---|---|
| | | 1 | 2 | 3 | 21 | 22 | 23 |
| Number of through holes | | 81 | 81 | 81 | 765 | 765 | 102 |
| Diameter ϕ_{T} | Average ϕ_{Tave} (μm) | 51.2 | 53.6 | 45.2 | 93.5 | 102.7 | 34.3 |
| of specific opening | 3σ (μm) | 0.9 | 2.4 | 1.7 | 7.3 | 19.7 | 1.9 |
| | 3σ/ϕ_{Tave} (%) | 1.7 | 4.6 | 3.7 | 7.8 | 19.2 | 5.4 |
| P_{T}/ϕ_{T} | Average (%) | 3.0 | 2.7 | 3.2 | 1.7 | 1.4 | 7.5 |
| among through | Maximum (%) | 6.2 | 3.2 | 5.7 | 6.1 | 4.2 | 13.7 |
| holes | Minimum (%) | 2.5 | 2.4 | 2.6 | 1.3 | 1.1 | 5.0 |

| | | | | | | |
|---|---|---|---|---|---|---|
| Average ϕ_{Nave} of the minimum dimension | 32.2 | 34.0 | 35.2 | 31.8 | 74.6 | 18.2 |
| ϕ_{N} of the narrow segment among | | | | | | |
| selected through holes (μm) | | | | | | |
| (ϕ_{N}/ϕ_{T}) (%) | 59 to 64 | 62 to 68 | 74 to 81 | 32 to 35 | 73 to 75 | 53 to 58 |

FIG. 12 illustrates an example of a photomicrograph of selected through holes.

In FIG. 12, the upper part shows the first surface of the glass plate, the middle part shows the cross section of the selected through holes, and the lower part shows the shape of the second surface of the glass plate.

From FIG. 12, it was understood that both the first openings and the second openings were very close to perfect circles. In fact, also in the results shown in Table 2, the average of P_{T}/φ_{T} was 3.0%, and also, the maximum value was a low value of 6.2%.

Also, from FIG. 12, it was understood that any of the narrow segments of the selected through holes was not very significant. In fact, as shown in Table 2, (φ_{N}/φ_{T}) were greater than or equal to 59%, which were large values.

Further, as shown in Table 2, 36/φ_{Tave} was a low value of 1.7%. From this, it was understood that the variation in the diameter φ_{T} of the specific opening was small among the respective through holes.

### Example 2

A glass plate having a large number of through holes was formed by using substantially the same method as in Example 1.

However, in this Example 2, an alkali-free glass having a dielectric loss tangent at the 10 GHz of less than or equal to 0.005, which is different from Example 1, was used as the glass base material. Also, the immersion time in the etching solution was set to 166 minutes. The etching rate during the applied etching process was 0.343 μm/min.

In columns of Example 2 in Table 1 and Example 2 in Table 2, the results of measurement of the dimensions of the formed through holes are collectively shown.

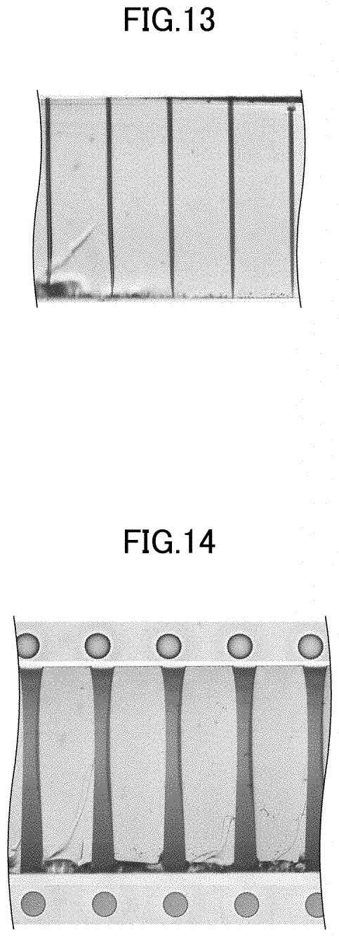

FIG. 13 illustrates an example of a cross-sectional photograph of initial through holes before the etching process. From FIG. 13, it can be seen that through holes having a high aspect ratio were formed.

FIG. 14 illustrates an example of a photomicrograph of selected through holes.

In FIG. 14, the upper part shows the first surface of the glass plate, the middle part shows the cross section of the selected through holes, and the lower part shows the shape of the second surface of the glass plate.

From FIG. 14, it was understood that both the first openings and the second openings were very close to perfect circles. In fact, also in the results shown in Table 2, the average of P_{T}/φ_{T} was 2.7%, and also, the maximum value was a low value of 3.2%.

Also, from FIG. 14, it was understood that any of the narrow segments of the selected through holes was not very significant. In fact, as shown in Table 2, (φ_{N}/φ_{T}) were greater than or equal to 62%, which were large values.

Further, as shown in Table 2, 36/φ_{Tave} was a low value of 4.6%. From this, it was understood that the variation in the diameter φ_{T} of the specific opening was small among the respective through holes.

### Example 3

A glass plate having a large number of through holes was formed by using substantially the same method as in Example 2.

However, in this Example 3, the temperature of the etching solution was set to 65° C. In addition, the immersion time of the glass base material in the etching solution was set to 540 minutes. The etching rate during the applied etching process was 0.083 μm/min.

In columns of Example 3 in Table 1 and Example 3 in Table 2, the results of measurement of the dimensions of the formed through holes are collectively shown.

FIG. 15 illustrates an example of a photomicrograph of selected through holes.

In FIG. 15, the upper part shows the first surface of the glass plate, the middle part shows the cross section of the selected through holes, and the lower part shows the shape of the second surface of the glass plate.

From FIG. 15, it was understood that both the first openings and the second openings were very close to perfect circles. In fact, also in the results shown in Table 2, the average of P_{T}/φ_{T} was 3.2%, and also, the maximum value was a low value of 5.7%.

Also, from FIG. 15, it was understood that any of the narrow segments of the selected through holes was not very significant. In fact, as shown in Table 2, (φ_{N}/φ_{T}) were greater than or equal to 74%, which were large values.

Further, as shown in Table 2, 36/φ_{Tave} was a low value of 3.7%. From this, it was understood that the variation in the diameter φ_{T} of the specific opening was small among the respective through holes.

### Example 21

A glass plate having a large number of through holes was formed by using substantially the same method as in Example 1.

However, in this Example 21, as the etching solution, an aqueous solution including hydrofluoric acid of 2.3 wt % and nitric acid of 6 wt % was used. Also, the temperature of the etching solution was set to 25° C.

The immersion time of the glass base material in the etching solution was set to 111 minutes. The average etching rate during the applied etching process was 0.901 μm/min.

In columns of Example 21 in Table 1 and Example 21 in Table 2, the results of measurement of the dimensions of the formed through holes are collectively shown.

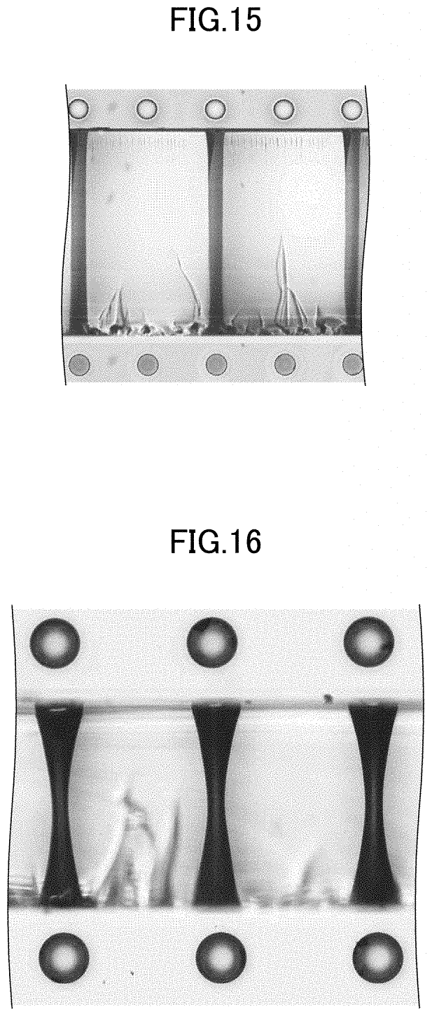

FIG. 16 illustrates an example of a photomicrograph of part of selected through holes.

In FIG. 16, the upper part shows the first surface of the glass plate, the middle part shows the cross section of the selected through holes, and the lower part shows the shape of the second surface of the glass plate.

From FIG. 16, it was understood that significant narrow segments were generated in the selected through holes. In fact, as shown in Table 2, (φ_{N}/φ_{T}) were less than or equal to 35%, which were small values.

Further, as shown in Table 2, 36/P_{Tave} was a relatively large value of 7.8%. From this, it was understood that the variation in the diameter φ_{T} of the specific opening was large among the formed through holes.

### Example 22

A glass plate having a large number of through holes was formed by using substantially the same method as in Example 21.

However, in this Example 22, ultrasonic vibration was applied to the solution during the etching process. Also, the immersion time of the glass base material in the etching solution was set to 94 minutes. The etching rate during the applied etching process was 1.043 μm/min.

In columns of Example 22 in Table 1 and Example 22 in Table 2, the results of measurement of the dimensions of the formed through holes are collectively shown.

FIG. 17 illustrates an example of a photomicrograph of part of selected through holes.

In FIG. 17, the upper part shows the first surface of the glass plate, the middle part shows the cross section of the selected through holes, and the lower part shows the shape of the second surface of the glass plate.

From FIG. 17, in Example 22, it was understood that any of the narrow segments of the selected through holes was not very significant.

However, as shown in Table 2, 36/φ_{Tave} was a large value of 19.2%. From this, in Example 22, it was understood that the variation in the diameter φ_{T} of the specific opening was large among the formed through holes.

### Example 23

A glass plate having a large number of through holes was formed by the following method.

As the glass base material, an alkali-free glass (AN100; manufactured by AGC Inc.) having a thickness of 0.3 mm was used.

Next, laser irradiation was carried out from the first surface side of the glass base material, to form modified portions extending from the first surface to the second surface along the thickness direction. As the laser, a picosecond pulse green laser was used. The laser irradiation power was set to 100 μJ, the repetition frequency was set to 200 kHz, and the processing was carried out by one shot.

Next, this glass base material was immersed in an etching solution to carry out an etching process.

As the etching solution, an aqueous solution including NaOH of 3 M and EDTA of 1.5 M was used. The temperature of the etching solution was set to 85° C., and the immersion time was set to 588 minutes.

After the etching process, the glass base material was taken out of the etching solution, to measure the thickness. As a result, it was understood that the glass base material was thinned by 0.04 μm. Therefore, the etching rate during the applied etching process was 0.068 μm/min.

After the etching process, a glass plate was formed in which a large number of through holes were formed. Each of the through holes has a first opening on the side of the first surface of the glass plate, and a second opening on the side of the second surface.

Thereafter, the shape of each of the through holes was measured by using substantially the same method as in Example 1.

In columns of Example 23 in Table 1 and Example 23 in Table 2, the results of measurement of the dimensions of the formed through holes are collectively shown.

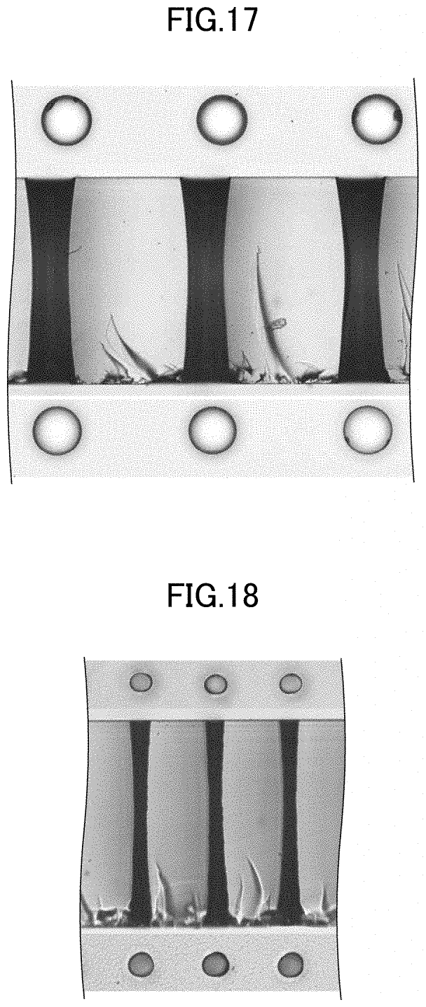

FIG. 18 illustrates an example of a photomicrograph of part of the selected through hole.

In FIG. 18, the upper part shows the first surface of the glass plate, the middle part shows the cross section of the selected through holes, and the lower part shows the shape of the second surface of the glass plate.

From FIG. 18, it was understood that in Example 23, the narrow segments of the selected through holes were not very significant.

However, in the selected through holes, it was understood that both the first openings and the second openings had elliptic shapes greatly deviating from a perfect circle. In fact, also in the results shown in Table 2, the average of P_{T}/φ_{T} was 7.5%, and the individual measured values were high values ranging from 5.0% to 13.7%.

In this way, in Example 23, it was understood that the shapes of the first openings and the second openings in the formed through holes were far from a perfect circle.

From the above results, it was confirmed that in Examples 1 to 3, through holes having a shape closer to a desired shape can be formed as compared with Examples 21 to 23.

1. A manufacturing method of a glass plate having one or more holes, the manufacturing method comprising:
(1) having a first surface of a glass base material irradiated with a laser, to form one or more initial holes each having a first initial opening on the first surface, the glass base material having the first surface and a second surface opposite to each other,
wherein each of the one or more initial holes is an initial through hole or an initial non-through hole,
wherein the first initial opening has a maximum dimension φ_{1S} (μm) of greater than or equal to 5 μm, and
wherein in each of the one or more initial holes, denoting a depth of the initial hole as d₁ (μm), an aspect ratio (d₁/φ_{1S}) of the initial hole is greater than or equal to 15; and
(2) applying an etching process to the glass base material with an alkaline solution, to form one or more processed holes from the one or more initial holes,
wherein each of the one or more processed holes has a first opening on the first surface, and
wherein the first opening has a diameter φ₁ (μm) defined as an average of a diameter of a circumscribed circle and a diameter of an inscribed circle of the first opening, and a roundness P₁ (μm), and a ratio P₁/φ₁ is less than or equal to 10% for each of the processed holes.

2. The manufacturing method as claimed in claim 1, wherein an etching rate in said (2) is less than or equal to 0.4 μm/min.

3. The manufacturing method as claimed in claim 1, wherein a temperature of the alkaline solution in said (2) is within a range of 50° C. to 95° C.

4. The manufacturing method as claimed in claim 1, wherein the laser is a UV laser.

5. The manufacturing method as claimed in claim 1, wherein the alkaline solution includes KOH, NaOH, or KOH and NaOH.

6. The manufacturing method of claim 1, wherein the glass base material has a thickness of greater than or equal to 0.1 mm.

7. The manufacturing method as claimed in claim 1, wherein the one or more processed holes are through holes, and
wherein, referring to five through holes selected at random from among the through holes as selected through holes, and denoting a minimum dimension of a narrow segment in cross section of each of the selected through holes as φ_{N} (μM), φ_{N}/φ₁ is greater than or equal to 0.5 for each of the selected through holes.

8. A glass plate comprising:
a first surface and a second surface opposite to each other; and
a plurality of through holes penetrating from the first surface to the second surface,
wherein each of the through holes has a first opening on the first surface and a second opening on the second surface, a larger one of the first opening and the second opening being referred to as a specific opening,
wherein the specific opening has a diameter φ_{T}(μm) determined as an average of a diameter of a circumscribed circle and a diameter of an inscribed circle of the specific opening, and a roundness P_{T}(μm), and a ratio P_{T}/φ_{T} is less than or equal to 10% for each of the through holes,
wherein, denoting an average value of the diameter φ_{T} of the specific opening among the through holes as φ_{Tave} (μm), and denoting a standard deviation of the diameter φ_{T} as σ (μm), 3σ/φ_{Tave} is less than or equal to 0.1, and
wherein, referring to five through holes selected at random from among the through holes as selected through holes, and denoting a minimum dimension of a narrow segment in cross section of each of the selected through holes as φ_{N} (μm), φ_{N}/φ_{T} is greater than or equal to 0.5 for each of the selected through holes.
